(19) United States
(12) Patent Application Publication
(10) Pub. No.: US 2023/0083065 A1
(43) Pub. Date: Mar. 16, 2023

(54) CURTAIN AIRBAG FOR VEHICLE

(71) Applicants: Hyundai Motor Company, Seoul (KR); Kia Corporation, Seoul (KR)

(72) Inventors: Jae Ho CHOI, Seoul (KR); Yoon Suk Lim, Suwon-Si (KR)

(21) Appl. No.: 17/868,608

(22) Filed: Jul. 19, 2022

(30) Foreign Application Priority Data
Sep. 16, 2021 (KR) 10-2021-0123816

(51) Int. Cl. B60R 21/232; B60R 21/2338; B60R 21/0136

(52) U.S. Cl. CPC B60R 21/232; B60R 21/2338; B60R 21/0136

(57) ABSTRACT

A curtain airbag apparatus of a vehicle includes: a main chamber mounted on the vehicle from a side of an occupant, and configured to be deployed by being supplied gas therein, and pressurized in colliding with the occupant in the deployed state; a vent hole spaced from an inflow path through which the gas flows into the main chamber, and opened for the gas inside the main chamber to flow; and a venting chamber connected to the main chamber so that the gas inside the main chamber flows into through the vent hole, wherein a gas flow through the vent hole from the main chamber to the venting chamber is restricted within the vent hole or the venting chamber.

### CROSS REFERENCE TO RELATED APPLICATION

The present application claims priority to Korean Patent Application No. 10-2021-0123816, filed Sep. 16, 2021, the entire contents of which is incorporated herein for all purposes by this reference.

### BACKGROUND OF THE PRESENT DISCLOSURE

### Field of the Present Disclosure

The present disclosure relates to a curtain airbag apparatus for a vehicle, and more particularly, to a curtain airbag apparatus configured to prevent a driver from directly colliding with vehicle interior portions and from injuries caused by driver's head rotation in an inclined collision of the vehicle.

### Description of Related Art

As interest in passenger safety increases along with vehicle functionality and convenience, safety-related devices capable of protecting passengers in the event of an accident are increasingly important. Among safety devices for protecting passengers, an airbag system, in particular, is the most basic protection device for dispersing the impact force exerted on a passenger in a vehicle crash situation.

There are various types of airbags, such as side airbags or curtain airbag apparatus that deploy along the side windows in case of a side collision, as well as those for the front of the driver's and front passenger's seats. The airbag system related to a side collision of a vehicle is usually divided into a curtain airbag apparatus of protecting the head of a passenger and a side airbag for protecting the sides of the chest of a passenger.

Generally, a curtain airbag apparatus cushion is a device that protects the heads of passengers sitting in the front and rear seats by being provided long from front to rear of a vehicle along the side of a roof panel of the car, and deployed between a door glass and the passenger when gas flows in through an inflator.

However, the conventional curtain airbag apparatus has a problem in that the possibility of occupant injury is high due to the high internal pressure of the airbag cushion caused when the head of an occupant collides with the airbag cushion in a vehicle inclined collision situation.

To solve the present problem, a technology for reducing the impact force applied to the occupant by first charging the gas in a main chamber of the airbag cushion and moving the gas to a venting chamber located nearby when the occupant's head collides with the main chamber is being developed.

The information included in this Background of the present disclosure section is only for enhancement of understanding of the general background of the present disclosure and may not be taken as an acknowledgement or any form of suggestion that this information forms the prior art already known to a person skilled in the art.

### BRIEF SUMMARY

Various aspects of the present disclosure are directed to providing a vehicle curtain airbag apparatus technology that reduces injuries by allowing gas to flow into a venting chamber when the rear seat occupant's head collides with the airbag.

In various aspects of the present disclosure, there is provided a curtain airbag apparatus of a vehicle including: a main chamber mounted on the vehicle from a side of an occupant, and configured to be deployed by being supplied gas therein, and pressurized in colliding with the occupant in the deployed state; a vent hole spaced from an inflow path through which the gas flows into the main chamber, and opened for the gas inside the main chamber to flow; and a venting chamber connected to the main chamber so that the gas inside the main chamber flows in through the vent hole, wherein a gas flow through the vent hole from the main chamber to the venting chamber is restricted within the vent hole or the venting chamber.

According to an exemplary embodiment of the present disclosure, an inflator located in front of the main chamber in a front and rear direction of the vehicle and configured to supply gas to the main chamber located in the rear through the inflow path may be further included.

The venting chamber is located in front of the main chamber in the front and rear direction of the vehicle, and may be spaced from the inflator in an up and down direction thereof.

The gas flow through the vent hole from the main chamber to the venting chamber may be in a direction opposite to the inflow path.

The venting chamber includes a plurality of chambers, and at least one partition wall configured to restrict gas flow between the chambers may be provided in the venting chamber.

The at least one partition wall may keep part of spaces between the chambers adjacent to each other among the chambers open while blocking remaining spaces.

The at least one partition wall is provided in plurality, and among the partition walls, open portions of the partition walls adjacent to each other may be disposed to be offset from each other in a gas flow direction in the venting chamber.

The gaps between the chambers are welded to block the gas flow, and when the main chamber is pressurized, the gaps between the chambers may be opened.

The vent hole is welded to block the gas flow to the venting chamber before the main chamber is pressurized, and when the main chamber is pressurized, the vent hole may be opened to allow the gas flow into the venting chamber.

The vent hole may be temporarily welded to be gradually opened due to the pressure caused by the pressurization of the main chamber.

A portion of the vent hole may be temporarily welded with a relatively low joint strength, and the remaining portion may be temporarily welded with a relatively high joint strength.

The vent hole may be an active vent which is maintained a blocked state and is opened at a preset time in case of vehicle impact or a collision between the occupant and the main chamber.

The venting chamber is located in front of the main chamber in the front and rear direction of the vehicle, and the curtain airbag apparatus of a vehicle may further include: a front chamber which is located in front of the venting chamber in the front and rear direction of the vehicle and communicates with the venting chamber so that the gas inside can flow into the venting chamber when pressurized.

The front chamber of the curtain airbag apparatus of the present disclosure is located on a side of a driver or passenger located in front of the occupant and pressurized when colliding with the driver or the passenger.

According to the curtain airbag apparatus of a vehicle of the present disclosure, it is possible to reduce the impact force exerted on the occupant's head by reducing the pressure of the airbag cushion when the occupant's head collides therewith.

Furthermore, venting is blocked and the main chamber is preferentially filled with gas before the occupant's head collides, and only after the collision, gas venting is allowed.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

### BRIEF DESCRIPTION OF THE DRAWINGS

FIG. 1 is a plan view of a curtain airbag apparatus of a vehicle according to the related art;

FIG. 2 is a view exemplarily illustrating the configuration of a vehicle in which a curtain airbag apparatus of a vehicle according to the related art is provided;

FIG. 3 is a plan view of a curtain airbag apparatus of a vehicle according to various exemplary embodiments of the present disclosure;

FIG. 4 is a graph illustrating a change in pressure inside a cushion according to a curtain airbag apparatus of a vehicle according to various exemplary embodiments of the present disclosure;

FIG. 5 is a plan view of a curtain airbag apparatus of a vehicle according to various exemplary embodiments of the present disclosure;

FIG. 6 is a graph illustrating a change in pressure inside a cushion according to a curtain airbag apparatus of a vehicle according to various exemplary embodiments of the present disclosure;

FIG. 7 is an enlarged view of a curtain airbag apparatus of a vehicle according to various exemplary embodiments of the present disclosure;

FIG. 8 is a plan view of a curtain airbag apparatus of a vehicle according to various exemplary embodiments of the present disclosure;

FIG. 9 is a graph illustrating a change in pressure inside a cushion according to a curtain airbag apparatus of a vehicle according to various exemplary embodiments of the present disclosure; and

FIG. 10 is a plan view of a curtain airbag apparatus of a vehicle according to various exemplary embodiments of the present disclosure.

It may be understood that the appended drawings are not necessarily to scale, presenting a somewhat simplified representation of various features illustrative of the basic principles of the present disclosure. The specific design features of the present disclosure as included herein, including, for example, specific dimensions, orientations, locations, and shapes will be determined in part by the particularly intended application and use environment.

In the figures, reference numbers refer to the same or equivalent parts of the present disclosure throughout the several figures of the drawing.

### DETAILED DESCRIPTION

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments of the present disclosure. On the other hand, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

Specific structural and functional descriptions of embodiments of the present disclosure disclosed herein are only for illustrative purposes of the embodiments of the present disclosure. The present disclosure may be embodied in many different forms without departing from the spirit and significant characteristics of the present disclosure. Therefore, the embodiments of the present disclosure are disclosed only for illustrative purposes and should not be construed as limiting the present disclosure.

Reference will now be made in detail to various embodiments of the present disclosure, specific examples of which are illustrated in the accompanying drawings and described below, since the embodiments of the present disclosure can be variously modified in many different forms. While the present disclosure will be described in conjunction with exemplary embodiments thereof, it is to be understood that the present description is not intended to limit the present disclosure to those exemplary embodiments of the present disclosure. On the other hand, the present disclosure is directed to cover not only the exemplary embodiments of the present disclosure, but also various alternatives, modifications, equivalents and other embodiments which may be included within the spirit and scope of the present disclosure as defined by the appended claims.

It will be understood that, although the terms “first”, “second”, etc. may be used herein to describe various elements, these elements should not be limited by these terms. These terms are only used to distinguish one element from another element. For instance, a first element discussed below could be termed a second element without departing from the teachings of the present disclosure. Similarly, the second element could also be termed the first element.

It will be understood that when an element is referred to as being “coupled” or “connected” to another element, it may be directly coupled or connected to the other element or intervening elements may be present therebetween. In contrast, it may be understood that when an element is referred to as being “directly coupled” or “directly connected” to another element, there are no intervening elements present. Other expressions that explain the relationship between elements, such as “between”, “directly between”, “adjacent to”, or “directly adjacent to” may be construed in the same way.

The terminology used herein is for describing various exemplary embodiments only and is not intended to be limiting. As used herein, the singular forms “a”, “an” and “the” are intended to include the plural forms as well, unless the context clearly indicates otherwise. It will be further understood that the terms “comprise”, “include”, “have”, etc. When used in the exemplary embodiment, specify the presence of stated features, integers, steps, operations, elements, components, and/or combinations thereof but do not preclude the presence or addition of one or more other features, integers, steps, operations, elements, components, and/or combinations thereof.

Unless otherwise defined, all terms including technical and scientific terms used herein have the same meaning as commonly understood by one of ordinary skill in the art to which the present disclosure belongs. It will be further understood that terms, such as those defined in commonly used dictionaries, should be interpreted as including a meaning which is consistent with their meaning in the context of the relevant art and the present disclosure, and will not be interpreted in an idealized or overly formal sense unless expressly so defined herein.

Hereinbelow, various exemplary embodiments of the present disclosure will be described in detail with reference to the accompanying drawings. Throughout the drawings, the same reference numerals will refer to the same or like parts.

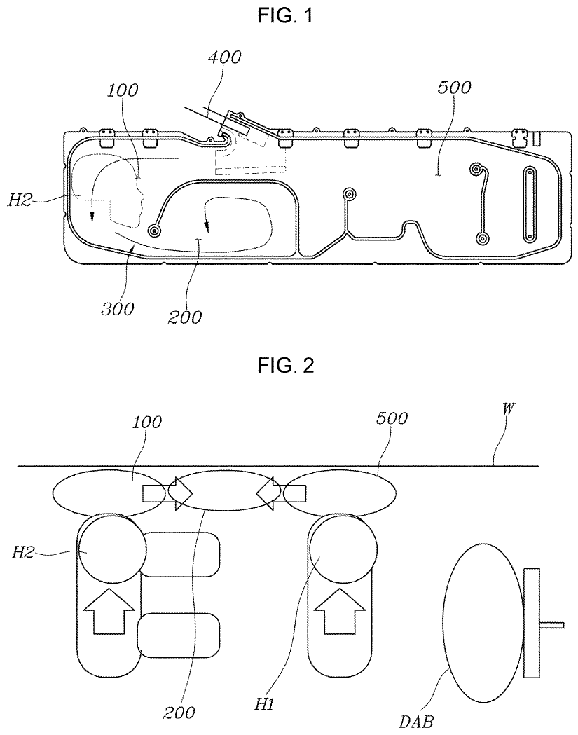

FIG. 1 is a plan view of a curtain airbag apparatus of a vehicle according to the related art, and FIG. 2 is a view exemplarily illustrating the configuration of a vehicle in which a curtain airbag apparatus of a vehicle according to the related art is provided.

Referring to FIGS. 1 to 2, in a curtain airbag apparatus of a vehicle according to the related art, an airbag cushion may be deployed from the internal surface side of the window W located on the side of the vehicle. The airbag cushion of the curtain airbag apparatus includes a main chamber 100, which is a portion of the airbag cushion in which the head of an occupant H2 collides, and a venting chamber 200 that communicates with the main chamber 100 to allow the gas inside the main chamber 100 to flow.

The main chamber 100 is connected to an inflator 400 so that the gas generated from the inflator 400 is primarily filled therein, and when the occupant's head collides and the main chamber 100 is pressurized, the gas inside flows into the venting chamber 200.

In the section in which the head of the occupant collides with the main chamber 100 and is restrained, the pressure of the main chamber 100 is maintained at the level of 25 [kPa] and may be maintained so as not to rise any more.

Here, the occupant may be a rear-seat passenger, and a driver or a passenger accommodated in the front passenger seat may be positioned in front of the occupant.

The main chamber 100 is located at a position where the head of the occupant collides, the venting chamber 200 may be located in front of the main chamber 100, and a front chamber 500 is further provided at a position where the driver's or the front-seat passenger H1's head collides, and the front chamber 500 may be located in front of the venting chamber 200 and connected to the venting chamber 200. A driver's seat airbag (DAB) may be positioned in front of the driver.

However, in the case of the curtain airbag apparatus of a vehicle according to the related art, as the gas generated in the inflator 400 flows into the main chamber 100 and the main chamber 100 is deployed, a portion of the gas flows into the venting chamber 200, slowing the rate at which the main chamber 100 is deployed.

Therefore, a technique for rapidly deploying the main chamber 100 first to restrain the occupant's head, and after that, allowing the gas of the main chamber 100 in which the occupant's head collided into the venting chamber 200 to flow was required.

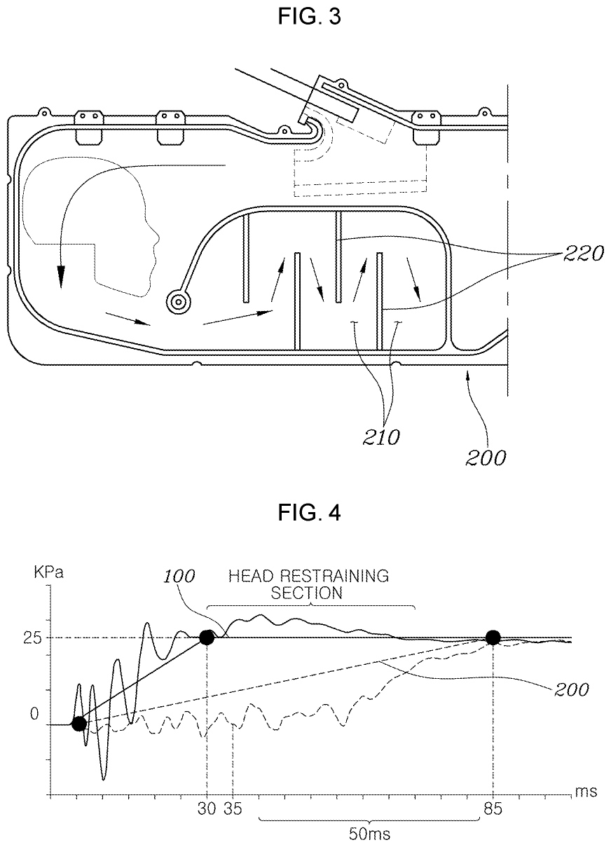

FIG. 3 is a plan view of a curtain airbag apparatus of a vehicle according to various exemplary embodiments of the present disclosure, and FIG. 4 is a graph illustrating a change in pressure inside a cushion according to a curtain airbag apparatus of a vehicle according to various exemplary embodiments of the present disclosure.

Referring to FIG. 3 and FIG. 4, a curtain airbag apparatus of a vehicle according to various exemplary embodiments of the present disclosure includes: a main chamber 100 configured to be mounted on the vehicle from the side of an occupant, deployed by being supplied gas therein, and pressurized in colliding with the occupant in the deployed state; a vent hole 300 configured to be spaced from an inflow path through which the gas flows into the main chamber 100, and opened for the gas inside the main chamber 100 to flow; and a venting chamber 200 configured to be connected to the main chamber 100 so that the gas inside the main chamber 100 flows in through the vent hole 300. A gas flow through the vent hole 300 from the main chamber 100 to the venting chamber 200 may be restricted within the vent hole 300 or the venting chamber 200.

The main chamber 100 is mounted on the side of the vehicle and may be deployed to cover the window W of the vehicle. The main chamber 100 is deployed to be located on the side of the head of the occupant (in an exemplary embodiment of the present disclosure, the rear-seat passenger) by being supplied gas therein, and the head of the occupant may collide with the deployed main chamber 100 during an inclined collision or a side collision of the vehicle.

The main chamber 100 may be connected to the venting chamber 200 through the vent hole 300, and the vent hole 300 may be spaced from the inflow path through which gas flows into the main chamber 100. In an exemplary embodiment of the present disclosure, the vent hole 300 may be located on the opposite side of the inflow path through which the gas flows into the main chamber 100, and may be opened in a direction opposite to the flow direction of the gas through the inflow path.

The venting chamber 200 communicates with the main chamber 100, and the venting chamber 200 and the main chamber 100 may be respectively disposed in the front and rear directions of the vehicle and connected together. According to an exemplary embodiment of the present disclosure, the venting chamber 200 may be positioned in front of the main chamber 100 and disposed at a position corresponding to the B pillar.

An inflator 400 which is located in front of the main chamber 100 in the front and rear direction of the vehicle and supplies gas to the main chamber 100 located in the rear through the inflow path may be further included.

The inflator 400 may generate gas by gunpowder or the like when a vehicle collision signal is input. The inflator 400 may allow gas to flow backward while being positioned in front of the main chamber 100 in the front and rear direction of the vehicle. In an exemplary embodiment of the present disclosure, the inflator 400 is positioned between the main chamber 100 and the front chamber 500 and communicates with the main chamber 100 and the front chamber 500 at the same time to supply gas at the same time.

The main chamber 100 may be deployed by receiving the gas generated from the inflator 400 through an inflow path connected to the inflator 400 positioned in the front.

The venting chamber 200 is located in front of the main chamber 100 in the front and rear direction of the vehicle, and may be spaced from the inflator 400 in the up and down direction thereof.

Both the inflator 400 and the venting chamber 200 may be positioned in front of the main chamber 100 in the front and rear direction of the vehicle, and the inflator 400 and the venting chamber 200 may be spaced from each other in the vertical direction.

As shown, the inflator 400 and the venting chamber 200 according to an exemplary embodiment are positioned to overlap in the front and rear direction of the vehicle, and the inflator 400 may be positioned above the venting chamber 200.

A gas flow through the vent hole 300 from the main chamber 100 to the venting chamber 200 may be in a direction opposite to the inflow path.

In an exemplary embodiment of the present disclosure, the inflow path through which the gas flows from the inflator 400 to the main chamber 100 is a direction from the front to the rear, and the direction in which the gas flows from the main chamber 100 to the venting chamber 200 through the vent hole 300 is a direction from the rear to the front, hence the two directions may be opposite to each other. Accordingly, it is possible to prevent the gas flowing into the main chamber 100 from flowing out, before the main chamber 100 is pressurized, into the venting chamber 200.

At the initial stage of deployment of the airbag cushion, gas flows into the main chamber 100, and at the instant time, the gas flow from the main chamber 100 through the vent hole 300 to the venting chamber 200 may be blocked. The gas flow may be restricted in the vent hole 300 or in the venting chamber 200.

In an exemplary embodiment of the present disclosure, the venting chamber 200 includes a plurality of continuous chambers 210, and at least one partition wall 220 restricting gas flow between the plurality of continuous chambers 210 may be provided.

The venting chamber 200 may have a shape in which a plurality of divided continuous chambers 210 are continuously connected, and the gas flowing through the vent hole 300 may flow while sequentially passing through the plurality of continuous chambers 210. Also, the plurality of continuous chambers 210 may be partitioned by one or more partition walls 220, and gas flow may be restricted by the partition walls 220.

The partition wall 220 may keep part of spaces between the continuous chambers 210 adjacent to each other among the plurality of continuous chambers 210 open while blocking remaining spaces.

In an exemplary embodiment of the present disclosure, the partition wall 220 may be formed by joining airbag cushions together. Each partition wall 220 is positioned between the plurality of continuous chambers 210 to block gas flow, and only some regions of the plurality of continuous chambers 210 may be opened and communicated.

The partition wall 220 is provided in plurality, and among the plurality of partition walls 220, some open portions of the partition walls 220 adjacent to each other may be disposed to be offset from each other in a gas flow direction in the venting chamber 200.

When there is a plurality of partition walls 220, open portions of the plurality of partition walls 220 may be disposed to be offset from each other in a zig-zag manner. In an exemplary embodiment of the present disclosure, the other partition wall 220, positioned adjacent to the partition wall 220 disposed with the space between the continuous chambers 210 is opened in the upper region, may be disposed so that the space between the continuous chambers 210 is opened in the lower region. Accordingly, the gas flow through the plurality of continuous chambers 210 inside the venting chamber 200 may be induced to be as slow as possible.

The present configuration, as shown in FIG. 4, allows the internal pressure of the main chamber 100 to move slowly to the venting chamber 200, thus having an effect that the deployment of the venting chamber 200 is delayed. That is, the speed at which the venting chamber 200 is deployed is delayed.

Furthermore, the gaps between the plurality of continuous chambers 210 are temporarily welded to block the gas flow, and when the main chamber 100 is pressurized, the gaps between the plurality of continuous chambers 210 may be opened.

In the plurality of continuous chambers 210, the gas flow may be blocked by a temporary weld according to an exemplary embodiment to be described later, and as the main chamber 100 is pressurized, the temporary weld may be torn. According to an exemplary embodiment of the present disclosure, the space between the partition walls 220 that partition the plurality of continuous chambers 210 may be temporarily welded.

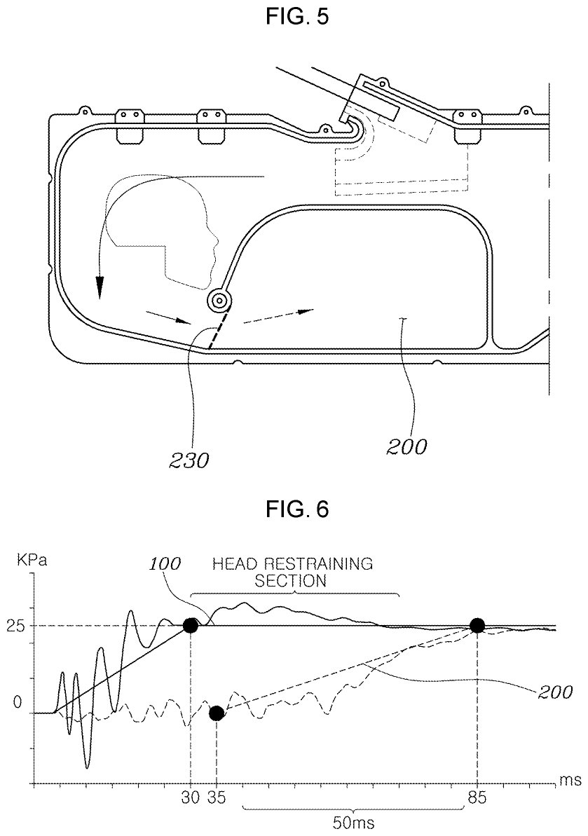

FIG. 5 is a plan view of a curtain airbag apparatus of a vehicle according to various exemplary embodiments of the present disclosure, and FIG. 6 is a graph illustrating a change in pressure inside a cushion according to a curtain airbag apparatus of a vehicle according to various exemplary embodiments of the present disclosure.

Referring further to FIG. 5 and FIG. 6, the vent hole 300 is temporarily welded 230 to block the gas flow to the venting chamber 200 before the main chamber 100 is pressurized, and when the main chamber 100 is pressurized, it may be opened to allow gas flow into the venting chamber 200.

The temporary weld 230 is joining parts by sewing to block the gas flow, and may be torn when the pressure is increased by the pressurization of the main chamber 100. In another exemplary embodiment of the present disclosure, the temporary weld 230 may be done by an adhesive having a weak adhesive force, etc., and may be torn when the pressure rises.

In an exemplary embodiment of the present disclosure, the temporary weld 230 may be designed to torn and open when the internal pressure of the main chamber 100 is 40 [kPa] or more.

As shown in FIG. 6, when the vent hole 300 is temporarily welded 230, the pressure of the venting chamber 200 may increase from the time when the temporary weld 230 is released and the vent hole 300 is opened (35 [ms]), but before the release of the temporary weld 230, the flow of gas into the venting chamber 200 may be blocked.

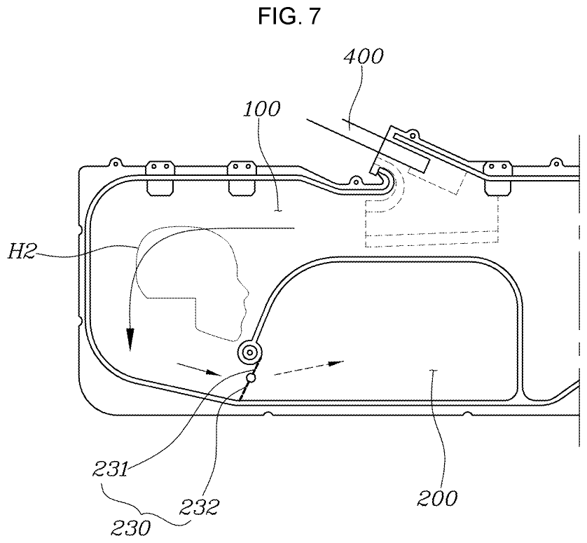

FIG. 7 is an enlarged view of a curtain airbag apparatus of a vehicle according to various exemplary embodiments of the present disclosure.

Referring further to FIG. 7, the vent hole 300 may be temporarily welded 230 to be gradually opened due to the pressure caused by the pressurization of the main chamber 100.

For example, the vent hole 300 may be temporarily welded 230 to be opened gradually as the pressure of the main chamber 100 increases. That is, the vent hole 300 may be divided into a plurality of regions and temporarily welded with different joint strengths, or joined with a gradually stronger or gradually weakened joint strength 231, 232.

In an exemplary embodiment of the present disclosure, a portion of the vent hole 300 may be temporarily welded with a relatively low joint strength 231, and the remaining portion may be temporarily welded with a relatively high joint strength 232.

It may be designed to open in two steps or in multiple steps so that a portion of the vent hole 300 is opened when the pressure of the main chamber 100 is 40 [kPa] or more, and the remaining portion is opened when the pressure of the main chamber 100 is 50 [kPa] or more. For example, a portion of the vent hole 300 is sewn at intervals of 5 [mm] and is temporarily welded 230 with a relatively low joint strength while the remaining portion of the vent hole 300 may be sewn at an interval of 4 [mm] to be temporarily welded 230 with a relatively high joint strength.

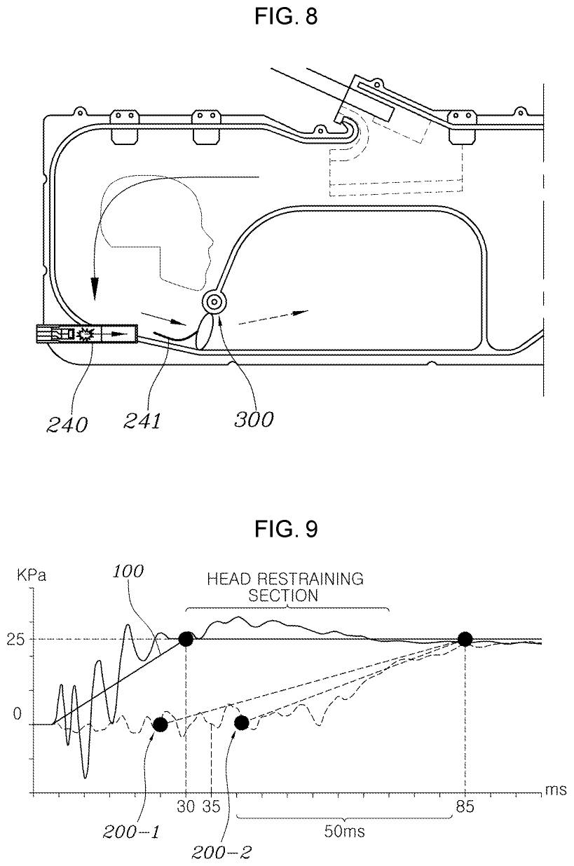

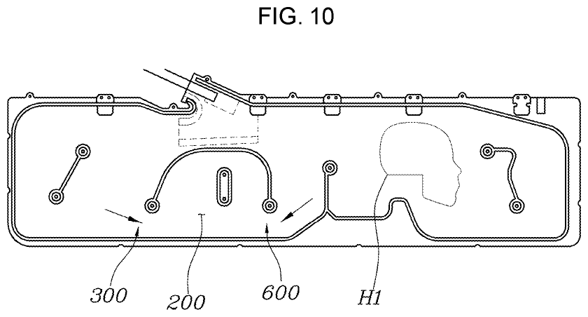

FIG. 8 is a plan view of a curtain airbag apparatus of a vehicle according to various exemplary embodiments of the present disclosure, and FIG. 9 is a graph illustrating a change in pressure inside a cushion according to a curtain airbag apparatus of a vehicle according to various exemplary embodiments of the present disclosure.

Referring further to FIGS. 8 to 9, the vent hole 300 may be an active vent which is maintained in a blocked state and is opened at a preset time in case of vehicle impact or a collision between the occupant and the main chamber 100.

In an exemplary embodiment of the present disclosure, the vent hole 300 is connected to a tether 241, and the gas flow through the vent hole 300 is blocked by the tension of the tether 241, and the coupling of the tether 241 is released at a preset time in case of the vehicle impact or the collision between the occupant and the main chamber 100, so that the gas flow through the vent hole 300 is allowed.

The tether 241 may be released by a Tether Release Unit (TRU) 240 or cut by a tether cutter 240 to open the vent hole 300. The TRU or the tether cutter 240 may be controlled by an airbag control unit (ACU) to be operated at a preset time in case of the impact of the vehicle or the collision between the occupant and the main chamber 100.

As shown in FIG. 9, before the active vent is opened, the pressure of the venting chamber 200 is maintained at 0, and after the active vent is opened, the gas may flow thereinto, increase the pressure. The pressure rising profile of the venting chamber 200 may be different depending on the timing at which the active vent is operated to open. The operating profile may be designed so that the active vent opens at the optimal timing depending on the vehicle model.

FIG. 10 is a plan view of a curtain airbag apparatus of a vehicle according to various exemplary embodiments of the present disclosure.

Referring further to FIG. 10, the venting chamber 200 is located in front of the main chamber 100 in the front and rear direction of the vehicle, the front chamber 500 which is located in front of the venting chamber 200 in the front and rear direction of the vehicle and communicates with the venting chamber 200 so that the gas inside can flow into the venting chamber 200 when pressurized may be further included.

The venting chamber 200 is located between the main chamber 100 and the front chamber 500, and the gas inside the main chamber 100 flows into the venting chamber 200 through the vent hole 300, and at the same time the venting chamber 200 communicates with the inside of the front chamber 500 so that the gas may be introduced therein. That is, the venting chamber 200 is located at a position corresponding to the B pillar between the main chamber 100 and the front chamber 500, and may communicate with the main chamber 100 and the front chamber 500 at the same time to relieve the internal pressure even when the main chamber 100 and the front chamber 500 are pressurized.

The front chamber 500 may be located on a side of a driver or passenger located in front of the occupant and pressurized when colliding with the driver or the passenger.

The front chamber 500 may be deployed in front of the B-pillar to protect a driver or a passenger located in front of the occupant in the second row.

In addition, the term related to a control device such as “controller”, “control apparatus”, “control unit”, “control device”, “control module”, or “server”, etc refers to a hardware device including a memory and a processor configured to execute one or more steps interpreted as an algorithm structure. The memory stores algorithm steps, and the processor executes the algorithm steps to perform one or more processes of a method in accordance with various exemplary embodiments of the present invention. The control device according to exemplary embodiments of the present invention may be implemented through a nonvolatile memory configured to store algorithms for controlling operation of various components of a vehicle or data about software commands for executing the algorithms, and a processor configured to perform operation to be described above using the data stored in the memory. The memory and the processor may be individual chips. Alternatively, the memory and the processor may be integrated in a single chip. The processor may be implemented as one or more processors. The processor may include various logic circuits and operation circuits, may process data according to a program provided from the memory, and may generate a control signal according to the processing result.

The control device may be at least one microprocessor operated by a predetermined program which may include a series of commands for carrying out the method disclosed in the aforementioned various exemplary embodiments of the present invention.

The aforementioned invention can also be embodied as computer readable codes on a computer readable recording medium. The computer readable recording medium is any data storage device that can store data which can be thereafter read by a computer system and store and execute program instructions which can be thereafter read by a computer system. Examples of the computer readable recording medium include hard disk drive (HDD), solid state disk (SSD), silicon disk drive (SDD), read-only memory (ROM), random-access memory (RAM), CD-ROMs, magnetic tapes, floppy discs, optical data storage devices, etc. and implementation as carrier waves (e.g., transmission over the Internet). Examples of the program instruction include machine language code such as those generated by a compiler, as well as high-level language code that may be executed by a computer using an interpreter or the like.

In an exemplary embodiment of the present invention, each operation described above may be performed by a control device, and the control device may be configured by multiple control devices, or an integrated single control device.

In an exemplary embodiment of the present invention, the control device may be implemented in a form of hardware or software, or may be implemented in a combination of hardware and software.

In addition, the terms such as “unit”, “module”, etc. disclosed in the specification mean units for processing at least one function or operation, which may be implemented by hardware, software, or a combination thereof.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described to explain certain principles of the present disclosure and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. A curtain airbag apparatus for a vehicle, the curtain airbag apparatus comprising:
a main chamber mounted on the vehicle from a side of an occupant, and configured to be deployed by being supplied gas therein, and pressurized in colliding with the occupant in the deployed state;
a vent hole spaced from an inflow path through which the gas flows into the main chamber, and opened for the gas inside the main chamber to flow; and
a venting chamber connected to the main chamber so that the gas inside the main chamber flows in through the vent hole,
wherein a gas flow through the vent hole from the main chamber to the venting chamber is restricted within the vent hole or the venting chamber.

2. The curtain airbag apparatus of claim 1, further including:
an inflator located in front of the main chamber in a front and rear direction of the vehicle and configured to supply the gas to the main chamber located in rear thereof through the inflow path.

3. The curtain airbag apparatus of claim 2, wherein the venting chamber is located in front of the main chamber in the front and rear direction of the vehicle, and spaced from the inflator in an up and down direction thereof.

4. The curtain airbag apparatus of claim 1, wherein the gas flow through the vent hole from the main chamber to the venting chamber is in a direction opposite to the inflow path.

5. The curtain airbag apparatus of claim 1, wherein the venting chamber includes a plurality of chambers, and at least one partition wall configured to restrict gas flow between the chambers is provided in the venting chamber.

6. The curtain airbag apparatus of claim 5, wherein the at least one partition wall keeps part of spaces between the chambers adjacent to each other among the chambers open while blocking remaining spaces.

7. The curtain airbag apparatus of claim 6, wherein the at least one partition wall is provided in plurality, and among the partition walls, open portions of the partition walls adjacent to each other are disposed to be offset from each other in a gas flow direction in the venting chamber.

8. The curtain airbag apparatus of claim 5, wherein gaps between the chambers are welded to block the gas flow, and when the main chamber is pressurized, the gaps between the chambers are opened.

9. The curtain airbag apparatus of claim 1, wherein the vent hole is welded to block the gas flow to the venting chamber before the main chamber is pressurized, and when the main chamber is pressurized, the vent hole is opened to allow the gas flow into the venting chamber.

10. The curtain airbag apparatus of claim 9, wherein the vent hole is welded and then opened due to pressure caused by the pressurization of the main chamber.

11. The curtain airbag apparatus of claim 9, wherein a portion of the vent hole is welded with a relatively low joint strength, and a remaining portion of the vent hole is welded with a relatively high joint strength so that the portion of the vent hole is opened when a pressure in the main chamber is equal to or greater than a first pressure and the remaining portion is opened when the pressure of the main chamber is equal to or greater than a second pressure which is greater than the first pressure.

12. The curtain airbag apparatus of claim 1, wherein the vent hole is an active vent hole which is configured to be maintained in a blocked state and to be opened at a preset time in response to vehicle impact or a collision between the occupant and the main chamber.

13. The curtain airbag apparatus of claim 12, wherein the active vent hole includes a tether, and the gas flow through the active vent hole is blocked by a tension of the tether to maintain the blocked state of the active vent hole.

14. The curtain airbag apparatus of claim 13,
wherein the tether is released by Tether Release Unit (TRU) or a tether cutter to open the active vent hole at the preset time, and
wherein the TRU or the tether cutter is controlled by an airbag control unit (ACU) to be operated at the preset time in case of the vehicle impact or the collision between the occupant and the main chamber.

15. The curtain airbag apparatus of claim 1,
wherein the venting chamber is located in front of the main chamber in a front and rear direction of the vehicle, and
wherein the curtain airbag apparatus further includes a front chamber which is located in front of the venting chamber in the front and rear direction of the vehicle and communicates with the venting chamber so that the gas inside the front chamber flows into the venting chamber when pressurized.

16. The curtain airbag apparatus of claim 14, wherein the front chamber is located on a side of a driver or passenger located in front of the occupant and pressurized when colliding with the driver or the passenger.
